(19) United States
(12) Patent Application Publication
(10) Pub. No.: US 2020/0225132 A1
(43) Pub. Date: Jul. 16, 2020

(54) REAL-TIME CONSUMABLE PARTS MONITORING SYSTEM

(71) Applicant: FORUM US, INC., Houston, TX (US)

(72) Inventors: Chris HARSHBARGER, Cypress, TX (US); Shane RICHARD, Tomball, TX (US); Ryan S. WILLIAMS, Houston, TX (US); Bao Q. TRUONG, Cypress, TX (US)

(21) Appl. No.: 16/247,885

(22) Filed: Jan. 15, 2019

(51) Int. Cl. G01N 3/02; G05B 19/4063

(52) U.S. Cl. CPC G01N 3/02; G05B 2219/24033; G05B 19/4063

(57) ABSTRACT

A system for monitoring a consumable part of a piece of equipment in real time comprises a piece of equipment, one or more operating sensors coupled to the piece of equipment, and an onboard processing transceiver coupled to the piece of equipment and in communication with the operating sensors. The operating sensors are configured to measure operational data of the piece of equipment during operation. The onboard processing transceiver is configured to determine a remaining life of the consumable part.

### BACKGROUND

### Field

Embodiments of this disclosure relate to systems and methods for monitoring consumable parts in equipment utilized in oil and gas drilling operations.

### Description of the Related Art

Mud pumps and hydraulic fracturing (frac) pumps are two types of high pressure/high volume pumps utilized in the production of oil and gas. Presently these pumps are operated until the pump fails. After failure, the pump is taken out of service to be repaired.

In many cases the pump failure mode is due to failure of a relatively inexpensive consumable part within the pump. These consumable parts are not typically monitored closely during operations. As such, the damaged consumable part continues to deteriorate which typically damages other consumables and/or components of the pump. Thus, what could have been a relatively inexpensive repair to the one damaged consumable part turns into repair of multiple components of the pump. This is time intensive as well as expensive.

Therefore there is a need for new and improved systems and methods for monitoring consumables of a pump during operation.

### SUMMARY

In one embodiment, a system for monitoring a consumable part of a piece of equipment in real time comprises a piece of equipment having a consumable part; one or more operating sensors coupled to the piece of equipment, wherein the operating sensors are configured to measure operational data of the piece of equipment during operation; a processing transceiver coupled to the piece of equipment and in communication with the operating sensors, wherein the onboard processing transceiver is configured to calculate performance data of the piece of equipment; and a controller or cloud based system in communication with the processing transceiver and configured to predict failure of the consumable part based on the remaining life of the consumable part as calculated using the performance data.

In one embodiment, a method for monitoring a consumable part of a piece of equipment in real time comprises receiving operational data from one or more operating sensors that are coupled to the piece of equipment; calculating stress data based on the operational data; calculating fatigue data and/or cumulative damage data based on the stress data, wherein the stress data and the fatigue data and/or cumulative damage data are calculated by a processing transceiver coupled to the piece of equipment, wherein the operational data, the stress data, and the fatigue data and/or cumulative damage data are output in the form of performance data; transmitting the performance data to a controller or cloud based system; and predicting failure of the consumable part based on a remaining life of the consumable part as calculated using the performance data via the controller or cloud based system.

### BRIEF DESCRIPTION OF THE DRAWINGS

So that the manner in which the above-recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic diagram of one embodiment of a real-time performance monitoring and predictive maintenance system for determining the structural health of a piece of equipment in real time.

FIGS. 2A and 2B illustrate sectional views of a pump system at different operating positions depicting one embodiment of the real-time performance monitoring and predictive maintenance system.

FIG. 3 is a flow chart depicting one embodiment of a method utilizing the real-time consumable monitoring system of FIG. 1.

FIGS. 4A and 4B are examples of graphs illustrating operation curves of consumable parts of a piece of equipment over time.

FIG. 5 is a graph representing remaining life of a consumable of a piece of equipment over time.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments disclosed herein relate to a real-time consumable parts monitoring system configured to monitor consumable parts of a piece of equipment used in the oil and gas industry. The real-time consumable parts monitoring system includes one or more operating sensors configured to monitor the operating conditions of a piece of equipment in real time. The piece of equipment includes the entire piece equipment, a portion of the equipment, or a component of the equipment. The real-time consumable parts monitoring system as described herein includes a performance monitoring and predictive maintenance system configured to monitor conditions of consumable parts of a piece of equipment.

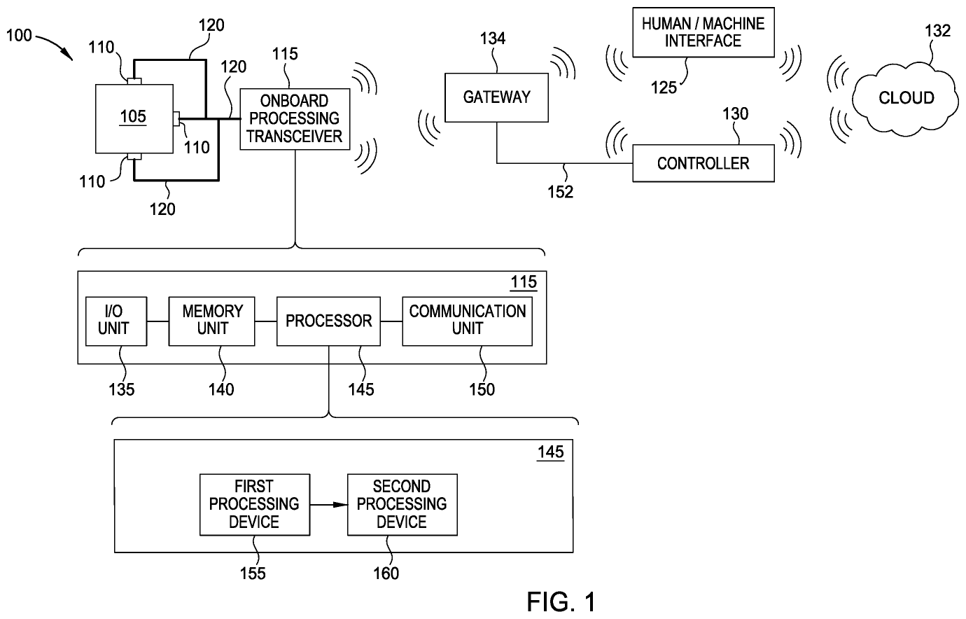

FIG. 1 is a schematic diagram of one embodiment of a real-time monitoring system 100 configured to monitor conditions of consumable parts in or on a piece of equipment 105. The piece of equipment 105 may be a mud pump or a frac pump. One or more operating sensors 110 are coupled to the piece of equipment 105. The consumable parts may be bearings, valves, seals, liners, a plunger or piston, springs, packing material, seats, as well as other component parts of the piece of equipment 105.

The operating sensors 110 are configured to gather operational data relating to the operation of the piece of equipment 105. The operational data includes location of the operating sensors 110, loading conditions, and/or boundary conditions. Location of the operating sensors 110 is utilized to determine the particular consumable part being monitored. Loading conditions include, but is not limited to, load, weight, stress, pressure, vibration, temperature, speed, current, and/or voltage. Boundary conditions include, but are not limited to, orientation data, position data, and/or angle data.

The operational data gathered by the operating sensors 110 is communicated to an onboard processing transceiver 115 via a wired connection 120. The onboard processing transceiver 115 is coupled (directly or indirectly) to the piece of equipment 105, and is dedicated to the piece of equipment 105 such that the onboard processing transceiver 115 travels with the piece of equipment 105 from one location to the next. The onboard processing transceiver 115 may be paired with a particular piece of equipment 105 for the operational lifetime of the piece of equipment 105.

The operational data transmitted to the onboard processing transceiver 115 from the operating sensors 110 via the wired connection 120 may be at a first frequency, such as about 60,000 data points per second. The operational data is processed by the onboard processing transceiver 115 to calculate stress and fatigue and/or cumulative damage as further described below. The onboard processing transceiver 115 is configured to transmit the operational data, the stress, and the fatigue and/or cumulative damage in the form of performance data to a human/machine interface 125, a controller 130, and/or a cloud based system 132 via a gateway 134 at a second frequency, such as about 120 data points per second, that is lower than the first frequency. The human/machine interface 125 and/or the controller 130 may be positioned at a location remote from the piece of equipment 105.

The onboard processing transceiver 115 includes an input/output unit 135, a memory unit 140, a processor 145, and a communication unit 150. The input/output unit 135 is configured to receive and/or retrieve the operational data from the operating sensors 110. The operational data can be stored in the memory unit 140 and communicated to the processor 145, which is configured to calculate the stress and fatigue and/or cumulative damage based on the operational data. The operational data, the stress, and the fatigue and/or cumulative damage can be stored in the memory unit 140, and communicated to the human/machine interface 125, the controller 130, and/or the cloud based system 132 wirelessly via the communication unit 150 and the gateway 134. The gateway 134 may be connected to the controller 130 via a wired connection 152.

The processor 145 includes a first processing device 155 and a second processing device 160. Each of the first processing device 155 and the second processing device 160 may include software containing an algorithm configured to perform the calculations described herein.

The first processing device 155 calculates stress of the piece of equipment 105 based on the operational data (such as loading conditions and boundary conditions) and outputs stress data. The stress data is communicated to the second processing device 160. The second processing device 160 calculates fatigue and/or cumulative damage of the piece of equipment 105 based on the stress data (such as by comparing a stress range over time) and outputs fatigue data and/or cumulative damage data. The operational data, the stress, and the fatigue data and/or cumulative damage data is communicated in the form of performance data to the controller 130 and/or the cloud based system 132 via the gateway 134.

The controller 130 and/or the cloud based system 132 is configured to identify the consumable part being monitored based on the performance data (e.g. the operational data received from the operating sensors 110) transmitted via the gateway 134. The controller 130 and/or the cloud based system 132 also contains a life prediction model that calculates the remaining life of one or more consumable parts based on a comparison with a system model, and therefore can predict failure of the one or more consumable parts. The controller 130 and/or the cloud based system 132 is configured to select a system model to use based on the performance data and/or the consumable part. The system model includes performance data based on normal operation of a piece of equipment that is similar to the piece of equipment 105.

For example, if the performance data from the operating sensors 110 includes data related to vibration, and the consumable part identified by the controller 130 and/or the cloud based system 132 is a valve, then the controller 130 and/or the cloud based system 132 will select a system model that includes data relating to vibration experienced by the same piece of equipment and/or consumable part during normal operation. Normal operation includes initial operation of the piece of equipment and/or operation of the piece of equipment after repair and/or maintenance. Multiple system models (e.g. that includes performance data relating to vibration) are preprogrammed into the controller 130 and/or the cloud based system 132.

The controller 130 and/or the cloud based system 132 compares the performance data with one or more system models to calculate the remaining life of the consumable part. For example, the controller 130 and/or the cloud based system 132 calculates remaining life of the consumable part of the piece of equipment 105 by comparing the fatigue data and/or cumulative damage data calculated by the onboard processing transceiver 115 to a system model having fatigue data and/or cumulative damage data based on traditional stress models. The controller 130 and/or the cloud based system 132 outputs the performance data, the consumable part identified, the system model, and/or the calculated remaining life of the consumable part in the form of working data to the human/machine interface 125. In response, one or a combination of the human/machine interface 125, the controller 130, and/or the cloud based system 132 may be configured to control the operation of the piece of equipment 105 based on the working data.

The human/machine interface 125 can be a display device where an operator can view the working data. The display device may be a personal computer, a screen coupled to the piece of equipment 105, and/or a cellular phone. The controller 130 can be a control device having a central processing unit and/or any other control mechanisms configured to receive and process the performance data, the consumable part identified, the system model, and/or the calculated remaining life of the consumable part, as well as control the operation of the piece of equipment 105. The cloud based system 132 can be a remote server accessible via the internet similarly configured to receive and process the performance data, the consumable part identified, the system model, and/or the calculated remaining life of the consumable part, as well as control the operation of the piece of equipment 105.

The human/machine interface 125, the controller 130, and/or the cloud based system 132 are configured to communicate with each other via wired and/or wireless communication to control the operation of the piece of equipment 105 based at least in part on the working data.

In one example, an operator can view the performance data, the consumable part identified, the system model, and/or the calculated remaining life of the consumable part on the human/machine interface 125 (as received and/or retrieved from the onboard processing transceiver 115, the controller 130, and/or the cloud based system 132) and then in response instruct the controller 130 to start, stop, and/or adjust the operation of the piece of equipment 105.

In one example, the controller 130 can automatically start, stop, and/or adjust the operation of the piece of equipment 105 based at least in part on the performance data, the consumable part identified, the system model, and/or the calculated remaining life of the consumable part on the human/machine interface 125 (as received and/or retrieved from the onboard processing transceiver 115, the controller 130, and/or the cloud based system 132) and then in response inform the operator via the human/machine interface 125.

In one example, the cloud based system 132 can automatically start, stop, and/or adjust the operation of the piece of equipment 105 (directly or via the controller 130) based at least in part on the performance data, the consumable part identified, the system model, and/or the calculated remaining life of the consumable part (as received and/or retrieved from the onboard processing transceiver 115, the controller 130, and/or the cloud based system 132) and then in response inform the operator via the human/machine interface 125.

The human/machine interface 125, the controller 130, and/or the cloud based system 132 are configured to calculate and/or log the operational history of the piece of equipment 105 based on the working data. The operational history can be obtained directly from one or more of the operating sensors 110, which data is passed through the onboard processing transceiver 115 as part of the performance data for processing and/or logging by the human/machine interface 125, the controller 130, and/or the cloud based system 132. The operational history includes at least one of information on cycles of the equipment and operational hours of the equipment.

The operational data is communicated on a continuous or as-needed basis to the onboard processing transceiver 115 in real time or near real time such that the working data, e.g. the performance data, the consumable part identified by the controller 130 and/or the cloud based system 132, the calculated remaining life of the consumable part, and/or any other operational data of the piece of equipment 105 or the consumable part is known on a real time basis. Based on the working data, the real-time monitoring system 100 can predict the remaining life of the consumable part, and therefore can predict failure of the one or more consumable parts as well as the remaining operating life of the piece of equipment 105, identify operating trends, as well as optimal service intervals to optimize the operating life of the equipment 105.

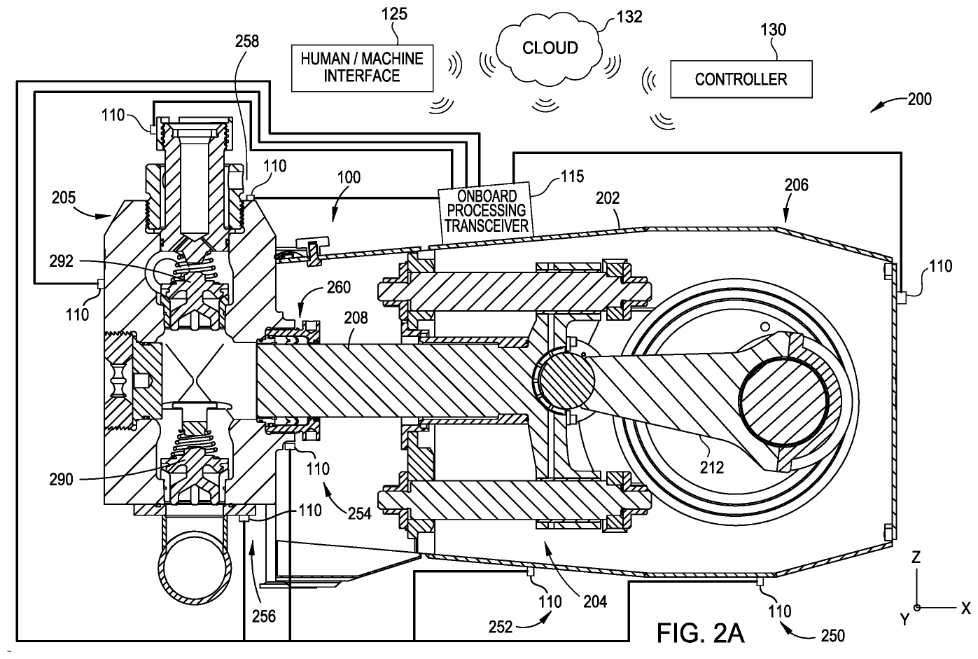

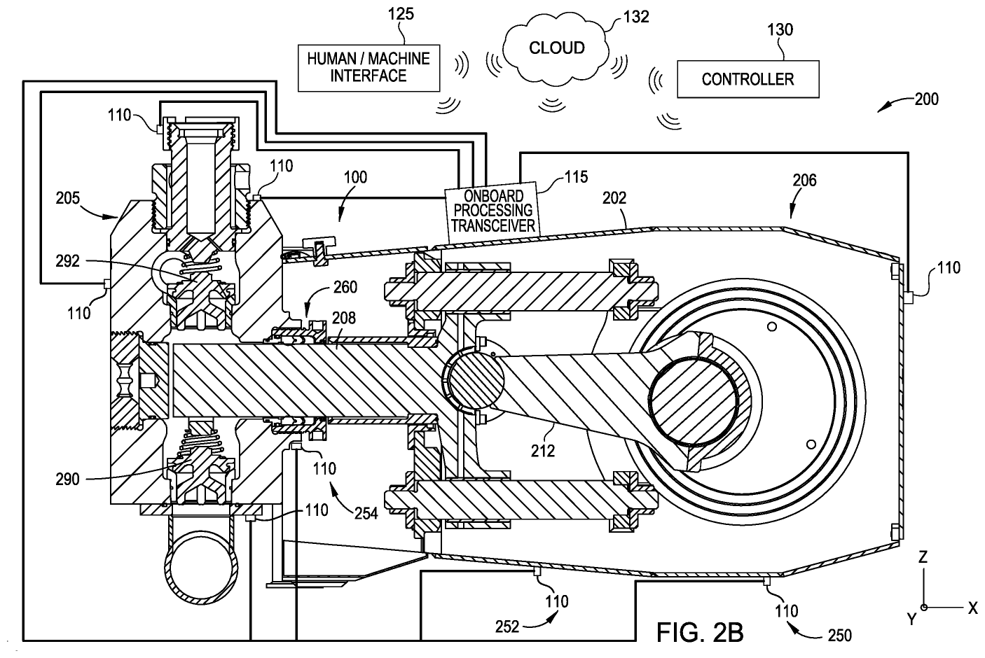

FIGS. 2A and 2B illustrate sectional views of a pump system 200 at different operating positions, according to one embodiment. The pump system 200 is shown in a fully retracted position in FIG. 2A and in a fully extended position in FIG. 2B. The pump system 200 depicted in FIGS. 2A and 2B is another example of the various types of equipment that the embodiments disclosed herein can be used with to determine remaining life of one or more consumable parts utilizing the real-time monitoring system 100. The operational data of the pump system 200 as measured by the operating sensors 110 is communicated to the onboard processing transceiver 115 to calculate the performance data as described herein and transmit the performance data to the human/machine interface 125, the controller 130, and/or the cloud based system 132, which then calculate the remaining life of one or more consumable parts of the piece of equipment 105.

The pump system 200 includes a power end 206 coupled to a fluid end 205. The power end 206 includes a crankshaft 212 coupled to a plunger assembly 204 in a pump housing 202. The plunger assembly 204 further includes a plunger 208 that extends into the fluid end 205. The fluid end 205 includes a suction valve 290 and a discharge valve 292. In operation, the plunger 208 is movable by the crankshaft 212 between the fully retracted position shown in FIG. 2A to draw fluid into the fluid end 205 through the suction valve 290 and the fully extended position shown in FIG. 2B to force fluid out of the fluid end 205 through the discharge valve 292.

The operating sensors 110 are shown coupled to the fluid end 205 and the power end 206 but can be coupled to any component of the pump system 200. The operating sensors 110 are configured to measure the operating conditions of the power end 206 and the fluid end 205 to gather operational data. The operating sensors 110 are configured to transmit the operational data to the onboard processing transceiver 115 for processing as described herein. In one example, the operating sensors 110 are configured to measure vibration of the fluid end 205 (such as by measuring the movement of the fluid end 205 using one or more accelerometers) during operation. In one example, the operating sensors 110 are configured to measure the position of the power end 206 using an angle encoder or a proximity sensor during operation. In one example, the operating sensors 110 are configured to determine the position of the plunger 208 by measuring the angle of the crankshaft 212.

In one example, the operating sensors 110 are configured to measure vibration of the plunger 208, such as by measuring velocity of the plunger 208 during operation. The vibration may be isolated near the crankshaft 212 at location 250 and/or location 252. Excessive vibration at locations 250, 252 may indicate a deterioration of a bearing assembly that is utilized with the crankshaft 212. The vibration may be isolated near the plunger assembly 204 at location 254. Excessive vibration at location 254 may indicate deterioration of packing material 260.

In one example, the operating sensors 110 are configured to measure vibration of the fluid end 205 at location 256 and/or location 258. Excessive vibration at location 256 and/or location 258 may indicate a deterioration of the suction valve 290 and the discharge valve 292, respectively, as well as seats and/or springs associated therewith.

In one example, the operating sensors 110 are configured to measure pressure(s) of the fluid end 205 at location 256 and/or location 258. Excessive inlet or outlet pressures at location 256 and/or location 258 may indicate a deterioration of the suction valve 290 and the discharge valve 292, respectively, as well as seats and/or springs associated therewith.

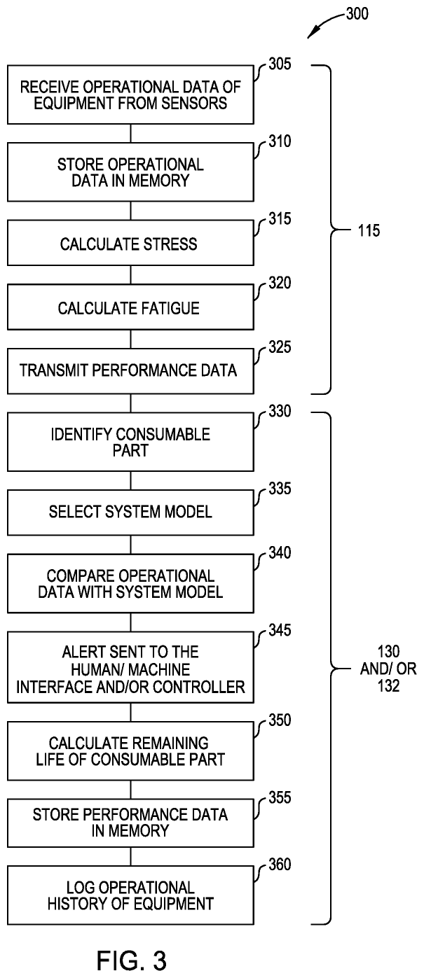

FIG. 3 is a flow chart depicting one embodiment of a method 300 utilizing the real-time monitoring system 100 of FIG. 1. The method 300 is utilized to determine the remaining life of one or more consumable parts (and therefore predict failure of the one or more consumable parts) in or on a piece of equipment, such as the piece of equipment 105 of FIG. 1, and/or the pump system of FIGS. 2A and 2B.

At step 305, the onboard processing transceiver 115 receives operational data of the piece of equipment from the operating sensors 110. The operational data includes location of the operating sensors 110, loading conditions, and/or boundary conditions. Loading conditions include, but is not limited to, load, weight, stress, pressure, vibration, temperature, speed, current, and/or voltage. Boundary conditions include, but are not limited to, orientation data, position data, and/or angle data. Vibration from the locating conditions includes vibrational frequencies measured by accelerometers or other types of vibration sensors. The operating sensors 110 measure and communicate the operational data regarding the consumable part and the piece of equipment in real time and continuously to the input/output unit 135 of the onboard processing transceiver 115 during operation of the piece of equipment.

Optionally, at step 310, the operational data may be stored on the memory unit 140 of the onboard processing transceiver 115.

At step 315, the first processing device 155 of the processor 145 of the onboard processing transceiver 115 calculates stress of the piece of equipment 105 based on the operational data (such as loading conditions and boundary conditions) and outputs stress data. The stress data is communicated to the second processing device 160.

At step 320, the second processing device 160 the processor 145 of the onboard processing transceiver 115 calculates fatigue and/or cumulative damage of the piece of equipment 105 based on the stress data (such as by comparing a stress range over time) and outputs fatigue data and/or cumulative damage data.

At step 325, the communication unit 150 of the onboard processing transceiver 115 transmits the operational data, the stress data, and the fatigue data and/or cumulative damage data in the form of performance data to the controller 130 and/or the cloud based system 132 via the gateway 134. The performance data can be communicated to the human/machine interface 125 via wireless communication at a frequency lower than the frequency that the operational data was communicated to the onboard processing transceiver 115.

At step 330, the controller 130 and/or the cloud based system 132 identifies the consumable part being monitored based on the performance data (e.g. the operational data received from the operating sensors 110 and/or the stress and fatigue and/or cumulative damage data as calculated by the onboard processing transceiver 115.

At step 335, the controller 130 and/or the cloud based system 132 selects a system model to use based on the performance data and/or the consumable part identified at step 330.

At step 340, the controller 130 and/or the cloud based system 132 compares the performance data of the consumable part with the system model.

Optionally, at step 345, an alert is sent to the human/machine interface 125 and/or the controller 130 if component failure is detected or imminent based on the system model comparison.

At step 350, based on the comparison of the performance data with the system model, the controller 130 and/or the cloud based system 132 calculates the remaining life of the consumable part.

Optionally, at step 355, the performance data may be stored on a memory unit of the controller 130 and/or the cloud based system 132.

At step 360, the human/machine interface 125, the controller 130, and/or the cloud based system 132 are configured to log the operational history of the consumable part and/or the piece of equipment.

One or a combination of the human/machine interface 125, the controller 130, and/or the cloud based system 132 are also configured to identify trends within the performance data, the remaining life, and/or the operational history to predict optimal equipment maintenance intervals. The cloud based system 132 may be used to gather operational history from one or more consumable parts of a single piece of equipment or from several pieces of equipment (e.g. an entire fleet of equipment), and compare the operational histories of all the pieces of equipment to identify trends and help predict optimal equipment maintenance intervals.

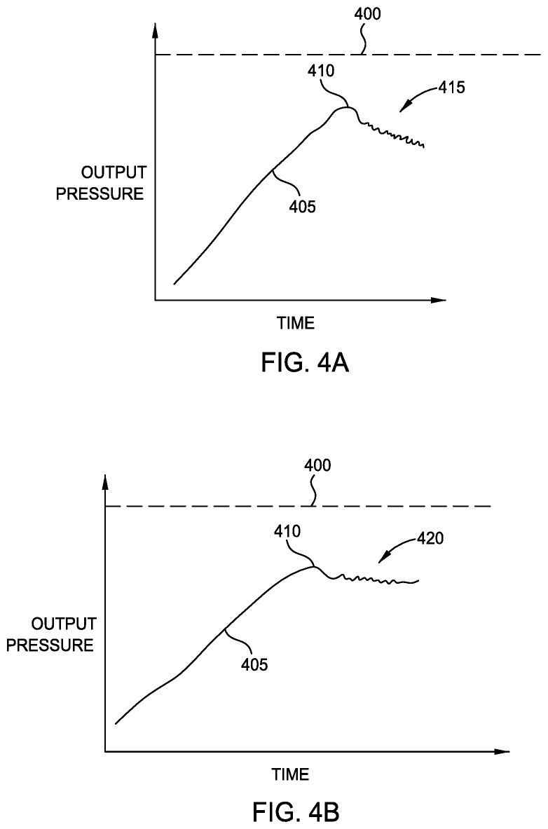

FIGS. 4A and 4B are examples of graphs illustrating operation curves of consumable parts of a piece of equipment over time. FIG. 4A represents an operation curve of a seal, such as the packing material 260 of FIGS. 2A and 2B. FIG. 4B represents an operation curve of a spring, such as in the valves of the pump system 200 of FIGS. 2A and 2B. In both of FIGS. 4A and 4B, the y-axis represents output pressure of fluids of the piece of equipment being monitored and the x-axis represents time (which may for example be in seconds, minutes, hours, days, weeks, months, or years). The dashed line 400 in each of FIGS. 4A and 4B represents a normal operating output pressure of the piece of equipment being monitored.

In FIGS. 4A and 4B, the output pressure of the piece of equipment is trending toward the normal operating output pressure as represented by dashed line 400. Lines 405 represent where the operation of the piece of equipment is considered normal operation and which may be stored as a system model. Points 410 represent a peak in operation where the respective consumable part begins to malfunction. The curve 415 in FIG. 4A indicates weeping of the seal, and curve 420 in FIG. 4B indicates chattering in the spring.

The onboard processing transceiver 115 is configured to gather the operational data regarding the output pressures as measured by the operating sensors 110, calculate the stress data and the fatigue data and/or cumulative damage data, and communicate the operational data, the stress data and the fatigue data and/or cumulative damage data in the form of performance data to the human/machine interface 125, the controller 130, and/or the cloud based system 132. The human/machine interface 125, the controller 130, and/or the cloud based system 132 are then configured to identify the consumable part associated with the performance data, select a system model (e.g. based on normal operation of the consumable part and/or piece of equipment), compare the performance data to the selected system model, and calculate the remaining life of the consumable part. The performance data and the remaining life of each respective consumable part may be as expected during the operation of the piece of equipment along line 405. However, the real-time monitoring system 100 may provide an indication of a shortened remaining life of the respective consumable parts during the operation of the piece of equipment along curves 415, 420 and therefore predict failure of the consumable parts.

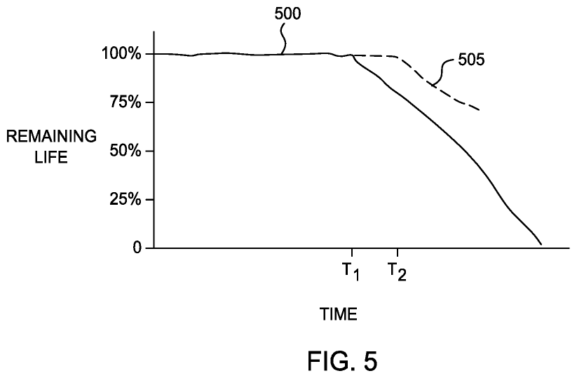

FIG. 5 is a graph representing percentage of remaining life of a consumable part of a piece of equipment over time. The consumable part may be a seal or a valve. Line 500 shows the predicted life of the consumable part operating at 100% under normal operating conditions until time T1 where efficiency of the consumable part drops. The predicted remaining life as indicted by line 500 may be preprogrammed into the controller 130 and/or the cloud based system 132 as a system model. Line 505 represents the actual remaining life of the consumable part as measured by the real-time monitoring system 100. The actual remaining life as indicated by line 505 is calculated by the controller 130 and/or the cloud based system 132 based on the performance data retrieved and/or received from the onboard processing transceiver 115 according to embodiments described herein.

As shown, the actual remaining life of the consumable part does not begin to decline until time T2, which allows an operator to schedule maintenance and/or replacement operations at a later time more optimal time. Alternatively, if the predicted remaining life of the consumable part under normal operating conditions is represented by line 505, and the actual remaining life as calculated by the real-time monitoring system 100 is represented by line 500, then an operator can schedule maintenance and/or replacement operations at an earlier time, thereby avoiding potential equipment failure and unexpected downtime. The failure of the consumable part (e.g. zero percent remaining life or any other percentage of remaining life that could cause the consumable part to fail can be predicted based on the measurement by the real-time monitoring system 100.

While the foregoing is directed to embodiments of the disclosure, other and further embodiments may be devised without departing from the basic scope thereof, and the scope thereof is determined by the claims that follow.

1. A system for monitoring a consumable part of a piece of equipment in real time, comprising:
a piece of equipment having a consumable part;
one or more operating sensors coupled to the piece of equipment, wherein the operating sensors are configured to measure operational data of the piece of equipment during operation;
a processing transceiver coupled to the piece of equipment and in communication with the operating sensors, wherein the onboard processing transceiver is configured to calculate performance data of the piece of equipment; and
a controller or cloud based system in communication with the processing transceiver and configured to predict failure of the consumable part based on the remaining life of the consumable part as calculated using the performance data.

2. The system of claim 1, wherein the processing transceiver comprises a first processing device configured to calculate stress data based on the operational data.

3. The system of claim 2, wherein the processing transceiver comprises a second processing device configured to calculate fatigue data and/or cumulative damage data based on the stress data.

4. The system of claim 3, wherein the controller or cloud based system are configured to calculate the remaining life of the consumable part based the fatigue data and/or cumulative damage data.

5. The system of claim 1, wherein the processing transceiver is configured to receive the operational data at a first frequency, process the operational data to calculate performance data, and transmit the performance data at a second frequency that is lower than the first frequency.

6. The system of claim 5, wherein the processing transceiver is configured to transmit the performance data at the second frequency to a human/machine interface, or the controller or cloud based system.

7. The system of claim 1, wherein the remaining life is output in the form of a graph indicating percentage of remaining life over time.

8. The system of claim 1, wherein the operating sensors are wired to the processing transceiver.

9. The system of claim 1, wherein the operational data includes operational history, loading conditions, and boundary conditions, wherein the operational history includes at least one of information on cycles of the equipment and operational hours of the equipment, wherein the loading conditions includes at least one of load, weight, stress, pressure, vibration, temperature, speed current, and voltage, and wherein the boundary conditions include at least one of orientation data, position data, and angle data.

10. The system of claim 1, wherein the processing transceiver is dedicated to the piece of equipment such that the processing transceiver travels with the piece of equipment.

11. A method for monitoring a consumable part of a piece of equipment in real time, comprising:
receiving operational data from one or more operating sensors that are coupled to the piece of equipment;
calculating stress data based on the operational data;
calculating fatigue data and/or cumulative damage data based on the stress data, wherein the stress data and the fatigue data and/or cumulative damage data are calculated by a processing transceiver coupled to the piece of equipment, wherein the operational data, the stress data, and the fatigue data and/or cumulative damage data are output in the form of performance data;
transmitting the performance data to a controller or cloud based system; and
predicting failure of the consumable part based on a remaining life of the consumable part as calculated using the performance data via the controller or cloud based system.

12. The method of claim 11, wherein the operational data includes operational history, loading conditions, and boundary conditions.

13. The method of claim 12, wherein the operational history includes at least one of information on cycles of the equipment and operational hours of the equipment.

14. The method of claim 12, wherein the loading conditions include at least one of load, weight, stress, pressure, vibration, temperature, speed, current, and voltage.

15. The method of claim 12, wherein the boundary conditions include at least one of orientation data, position data, and angle data.

16. The method of claim 11, further comprising transmitting the performance data and the remaining life a human/machine interface.

17. The method of claim 11, further comprising identifying the consumable part based on the performance data via the controller or cloud based system.

18. The method of claim 11, further comprising selecting a system model based on the performance data and comparing the performance data to the system model to calculate the remaining life of the consumable part.

19. The method of claim 11, further comprising controlling the operation of the piece of equipment based on the performance data or the remaining life of the consumable part.

20. The method of claim 11, wherein the piece of equipment is a pump.
